(19) United States
(12) Patent Application Publication
(10) Pub. No.: US 2021/0360892 A1
(43) Pub. Date: Nov. 25, 2021

(54) MILKING SYSTEM AND METHOD

(71) Applicant: Bullseye Australia PTY LTD, Beaconsfield (AU)

(72) Inventor: Richard Paul Wallace, Beaconsfield (AU)

(21) Appl. No.: 16/999,521

(22) Filed: Aug. 21, 2020

(30) Foreign Application Priority Data
May 20, 2020 (AU) 2020901629

(51) Int. Cl. A01J 5/04; A01J 5/007

(52) U.S. Cl. CPC A01J 5/047; A01J 5/007

(57) ABSTRACT

A differential vacuum system for use with a milking system. The differential vacuum system is configured to modulate the fluid pressure in the pulsation volume to cause a milking operation on a teat of an animal that is inserted into the bore of a liner. The pulsation cycle includes an “on” phase to open the liner and thereby enable milk flow from the teat, and an “off” phase in which the pulsation volume is at an increased pressure relative to the “on” phase to close the liner bore to thereby stop milk flow from the teat. The differential vacuum system controls the maximum vacuum applied to the pulsation volume to exceed the maximum vacuum applied to the liner bore.

This application claims priority to Australia Patent Application No. 2020901629, filed May 20, 2020, the entire content of which is incorporated by reference.

### TECHNICAL FIELD

The disclosure relates to systems and methods of milking mammals.

### BACKGROUND

Animals, such as cows, are generally milked utilizing a milking cup including a shell and a flexible liner. The liner includes a hollow bore for receiving an animal's teat at its upper end, and is connected to a vacuum source at its lower end via a milk line. Milk is vacuumed from the animal's teat via the milk line.

### SUMMARY

The disclosure relates to systems and methods of milking mammals. In particular, the disclosure relates to systems and methods for use in the milking of cows. In particular, although not exclusively, the disclosure relates to a differential vacuum system to differentiate the pressure applied to the pulsation chamber and the milk line in a milking system/method. While the disclosure is described in terms of a claw arrangement with four teat cups, it will be appreciated that the disclosure has application to other arrangements used in robotic and automated milking.

1. Pressure Differential in the Range of 5-10 kPa

In accordance with a first aspect of the present disclosure, there is provided, a differential vacuum system for use with a milking system which includes: at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and a vacuum system in fluid communication with the bore of the liner and the pulsation volume; and a milk reservoir in fluid communication with the liner bore and adapted to receive milk;

wherein the differential vacuum system is configured to modulate the fluid pressure in the pulsation volume to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore by more than 5 kPa.

Preferably the range is more than 5 kPa and up to 10 kPa.

In a related aspect, there is provided a method a method of milking a cow using a milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:

applying a vacuum to the liner;

modulating the pressure in the pulsation volume according to a pulsation cycle to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore by more than 5 kPa.

Preferably the range is more than 5 kPa and up to 10 kPa.

In yet another related aspect, there is provided a milking system including the differential vacuum system as set out in accordance with the first aspect.

The preferred pressure differential between the maximum vacuum applied to the pulsation volume and the maximum vacuum applied to the liner bore is preferably within the range of 7-7.5 kPa. The preferred pressure differential is 7 kPa. It will be understood that the pressure differentials exist at the start of milking, thereby achieving effective opening of the liner, without reliance upon the inherent resilience of the material, which as explained above erodes over time, particularly after 1600 milkings.

Any of the features set out below may have application to the first aspect of the disclosure.

2. Pressure Differential with 38 kPa Maximum Milk Line Vacuum

In accordance with the second aspect of the present disclosure, there is provided a differential vacuum system for use with a milking system which includes: at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; a vacuum system in fluid communication with the bore of the liner and the pulsation volume; and a milk reservoir in fluid communication with the liner bore and adapted to receive milk;

wherein the differential vacuum system is configured to modulate the fluid pressure in the pulsation volume to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore, with the maximum vacuum applied to the liner bore generally not exceeding 38 kPa.

In a related aspect, there is provided a method a method of milking a cow using a milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:

applying a vacuum to the liner;

modulating the pressure in the pulsation volume according to a pulsation cycle to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore with the maximum vacuum applied to the liner bore generally not exceeding 38 kPa.

In yet another related aspect, there is provided a milking system including the differential vacuum system as set out in accordance with the second aspect.

In a high line system, 39 kPa is required to be applied to the liner bore due to the vacuum losses resulting from the lifting of milk. Even with 39 kPa, other system losses may reduce the vacuum by one kPa, resulting in a maximum of 38 kPa at the liner bore.

In a low line system, the maximum vacuum applied to the liner bore may be designed to not exceed 35 kPa or 36 Kpa.

3. Differential Vacuum with Range of Residual Vacuum

In accordance with third aspect of the present disclosure, there is provided a differential vacuum system for use with a milking system which includes: at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; a vacuum system in fluid communication with the bore of the liner and the pulsation volume; and a milk reservoir in fluid communication with the liner bore and adapted to receive milk;

wherein the differential vacuum system is configured to modulate the fluid pressure in the pulsation volume to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore, such that the residual vacuum in the liner bore during the off phase is within the range of about 6-12 kPa.

In a related aspect, there is provided a method a method of milking a cow using a milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:

applying a vacuum to the liner;

modulating the pressure in the pulsation volume according to a pulsation cycle to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore with the maximum vacuum applied to the liner bore such that the residual vacuum within the liner bore during the off phase is within the range of about 6-12 kPa.

In yet another related aspect, there is provided a milking system including the differential vacuum system as set out in accordance with the third aspect.

More preferably, the residual vacuum within the liner bore during the off phase is within the range of 8-12 Kpa. Most preferably, the residual vacuum within the liner bore during the off phase is 6-8 kPa.

Positive Pressure

The above aspects of the disclosure may include applying positive pressure to the pulsation volume before and/or during the off phase to apply compressive load to the teat. This may be achieved with the differential vacuum system or alternatively a related pressure compensation system as disclosed in our earlier application PCT/AU 2017/050412. Such a pressure compensation system may include: a sensing system configured to measure a fluid parameter related to a pressure in the bore; and a controller configured to control the pressure compensation system to adjust a level of positive pressure air applied to the pulsation volume based on said determined fluid parameter measurement.

By way of example, in a low line system using a pressure compensation system, the maximum vacuum applied to the pulsation volume may be 42 kPa or more (say, 45 Kpa), while the maximum volume applied to the milk line may be 35 kPa. In contrast, in a high line system using a pressure compensation system, the maximum vacuum applied to the pulsation volume may be 48 kPa while the maximum vacuum applied to the milk line is 38 kPa.

The positive air pressure compensation preferably provides cyclical massage in the range of 22-26 kPa on the teat. The amount of positive air pressure compensation may be controlled by a control system as disclosed in our earlier application PCT/AU 2017/050412.

The compressive load may be applied to the teat in a manner that causes application of said load at the lowermost part of the teat before the application of compressive load higher up the teat. Compressive load is preferably initially applied to the lowermost 1 to 3 mm of the teat.

4. Pressure Differential and Positive Pressure

In accordance with a fourth aspect of the present disclosure, there is provided, a differential vacuum system for use with a milking system which includes: at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and a vacuum system in fluid communication with the bore of the liner and the pulsation volume;

wherein the differential vacuum system is configured to modulate the fluid pressure in the pulsation volume to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore and controls application of positive pressure to the pulsation volume before and/or during the off phase to apply compressive load to the teat.

In a related aspect, there is provided a method of milking a cow using a milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat, the method including:

applying a vacuum to the liner;

modulating the pressure in the pulsation volume according to a pulsation cycle to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore with the maximum vacuum applied to the liner bore and controls application of positive pressure to the pulsation volume before and/or during the off phase to apply compressive load to the teat.

In yet another related aspect, there is provided a milking system including the differential vacuum system as set out in accordance with the fourth aspect.

Any of the features described above in connection with foregoing aspects, may be applied to the present aspect.

5. Pressure Differential and Insert

In accordance with a fifth aspect of the present disclosure, there is provided, a milking system including:

at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and

a vacuum system in fluid communication with the bore of the liner and the pulsation volume;

a differential vacuum system configured to modulate the fluid pressure in the pulsation volume to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore; and

an insert to control the opening of the liner.

In a related aspect, there is provided a method of milking a cow using a milking cup of the type including a shell and a flexible liner, said liner including: a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and an insert between the liner and the shell to limit maximum distension of the liner, the method including:

applying a vacuum to the liner;

modulating the pressure in the pulsation volume according to a pulsation cycle to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore with the maximum vacuum applied to the liner bore.

Thus, the pressure differential created by having the maximum vacuum applied to the pulsation volume exceeding the maximum vacuum applied to the liner bore causes the liner to open more effectively throughout the milking cycle, reducing dependence upon the inherent resilience of the liner material and thus extending the effectiveness of the liner throughout its lifespan. The presence of the insert acts as a stop to limit the opening of the liner. This precludes over-opening which could occur due to the differential vacuum.

The pressure regulation system according to any of the aforementioned aspects is preferably configured to operate in accordance with a modulation pattern of the pressure in the pulsation volume to define a pulsation cycle including at least:

a “B phase” in which the teat is exposed to a vacuum by opening of open liner bore;

a “D” phase in which the liner bore is closed around the teat;

an “A phase” corresponding to a transition between the D phase and B phase; and a “C phase” corresponding to a transition between the B phase and D phase.

In any of the abovementioned aspects, the pulsation cycle may have a duration selected from any one or more of the following:

less than 950 ms, less than 900 ms; less than 850 ms; less than 800 ms; less than 750 ms; less than 700 ms; less than 675 ms; at or about 674 ms; 600 ms or above; 650 ms or above; 700 ms or above; 7500 ms or above; 800 ms or above; 850 ms or above; 900 ms or above; 950 ms or above; or within a range defined by any pair of the above listed durations.

In any of the abovementioned aspects the pulsation cycle has a repetition rate selected from any one of more of the following:

greater than 60 cycles per minute; greater than 70 cycles per minute; greater than 80 cycles per minute; greater than 90 cycles per minute; greater than 100 cycles per minute; at or about any one of 60, 70, 80, 89, 90, 100 cycles per minute; less than 70 cycles per minute; less than 80 cycles per minute; less than 90 cycles per minute; less than 100 cycles per minute; less than 110 cycles per minute, or at a rate within a range defined by any pair of the above listed frequencies. Preferably, the pulsation cycle is a repetition rate of 85 cycles per minute.

Other cycle times or phase times are also possible.

The present disclosure also provides a milking machine or milking system, which is commissioned in accordance with the method of any of the abovementioned aspects of the disclosure. The milking machine or system can generally be of the type described in ISO 6690:2007 (or similar standards that precede or supersede this standard). In particular the milking machine preferably includes a claw and a plurality of milking cups and a milk reservoir in fluid communication with the liner bore and adapted to receive milk.

The foregoing methods according to any of the aspects above may include selection of close fitting liners, designed to closely fit to the animal's teat. It is difficult to quantify a “close-fitting” liner because even a relatively small liner can be used on a large teat because the liner can be stretched due to the differential vacuum. Such a close-fitting liner will facilitate residual vacuum in the range of about 6-12 kPa. A close-fitting liner is necessary to achieve such low values of residual vacuum.

For example, a small liner may have an upper barrel diameter of approximately 22 mm and a mid barrel diameter of approximately 21 mm.

Dual milk lines from the cluster, for example as found in our earlier international patent application PCT/AU2018/050416 may also be implemented with any of the systems/methods as described above.

It will be understood that the examples disclosed and defined in this disclosure extends to all alternative combinations of two or more of the individual features mentioned or evident from the text or drawings. All of these different combinations constitute various alternative aspects of the disclosure. In particular, any of the features discussed in the foregoing aspects may be applied to any of the other aspects.

Further aspects of the present disclosure and further embodiments of the aspects described in the preceding paragraphs will become apparent from the following description, given by way of example and with reference to the accompanying drawings.

### BRIEF DESCRIPTION OF DRAWINGS

Embodiments of the present disclosure will be described by way of non-limiting example only with reference to the accompanying drawings.

FIG. 1a is a reproduction of FIG. 1a of PCT/AU2017/050412 application and illustrates a milking system in which a milking method according to an embodiment of the present disclosure may be implemented.

FIG. 1b shows another exemplary system and replicates FIG. 13 of PCT/AU2017/050412.

FIG. 2A is equivalent to FIG. 8 of PCT/AU2017/050412 and illustrates a milking cup including an insert which is usable in an embodiment of the present application.

FIG. 2B is a cross-sectional view through a liner, illustrating measurement locations.

FIG. 3A illustrates a pulsation cycle, and shows the four phases the pulsation cycle for the our Calf 35 and the conventional pulsation cycle.

FIG. 3B illustrates a pulsation cycle, and shows the four phases of the pulsation cycle for the applicant's Calf 35 run at 60 cycles per minute versus 80 cycles per minute.

FIG. 4 demonstrates in a conventional milking system, the declining liner performance, in terms of compressive load applied to the teats in the D phase, relative to number of milkings.

FIG. 5 demonstrates in a conventional milking system and the prior art milking system Calf 35, the declining liner performance, in terms of compressive load applied to the teats in the D phase, relative to number of milkings.

FIG. 6A is a diagram illustrating an exemplary system according to an embodiment of the present disclosure depicting a low-line milking system and high-line milking system implementing Calf 35 (aided with compressed air) to work at 85 CPM.

FIG. 6B is a diagram illustrating an exemplary system according to an embodiment of the present disclosure depicting a high-line milking system retrofitted with differential vacuum, to work at 65 to 72 CPM.

FIG. 7 illustrates a conventional pulsation cycle according to a system-applied maximum milk line vacuum of −45 kPa and a system-applied maximum pulsation volume vacuum of −45 kPa with the residual vacuum resulting therefrom; and secondly a pulsation cycle in a “differential-pressure” system according to the present disclosure with a system-applied maximum milk line vacuum of −35 kPa and a system-applied maximum pulsation volume vacuum of −45 kPa with the residual vacuum resulting therefrom; and thirdly illustrating the magnitude of difference between the vacuum on the teat from the conventional pulsation cycle and the differential-pressure pulsation cycle according to the present disclosure in both the off phase and the on phase.

FIG. 8 is a simplified version of FIG. 7 showing only the differential vacuum system according to the present disclosure.

FIG. 9A is a detail of the plot of FIG. 7 showing the difference in residual vacuum between conventional and the differential vacuum system according to the present disclosure.

FIG. 9B is a detail from the plot of FIG. 7 illustrating further potential improvement in the residual vacuum during the off phase.

FIG. 10 illustrates the improvement in relative open space in the liner bore between a conventional milking system, standard Calf 35, and Calf 35 implemented with differential pulsation/milk-line vacuum pressures.

FIG. 11 illustrates the improvement in compressive load using Calf 35 implemented with differential-pressure compared to the compressive load in a conventional system.

### DETAILED DESCRIPTION

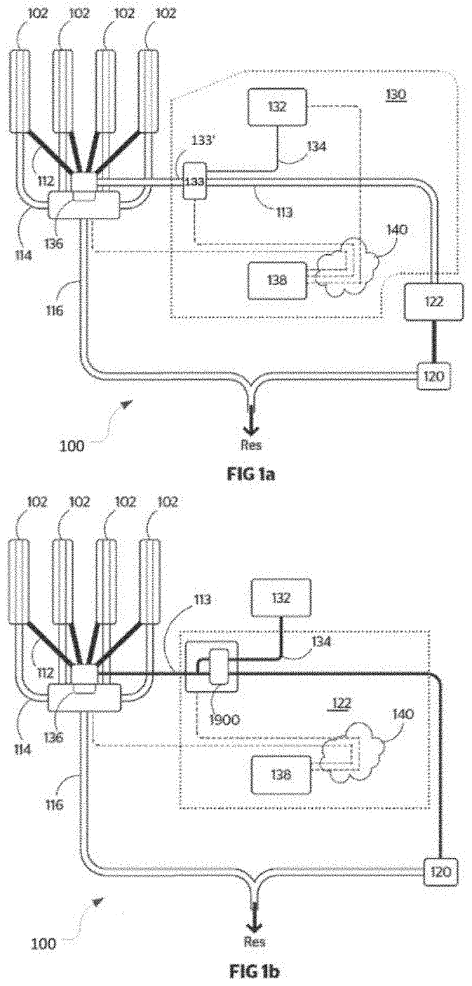

The applicant has previously disclosed in their earlier international patent applications PCT/AU2017/050412 and PCT/AU2019/050125, methods and systems for milking cows which can advantageously lead to better animal health. Such systems use a milking cup 102 (See FIG. 1) of the type including a shell and a flexible liner. The milking cups may be arranged in clusters of four, known as a “claw”. However, other arrangements of milking cups are found in automated and robotic milking.

Teat Cup Design

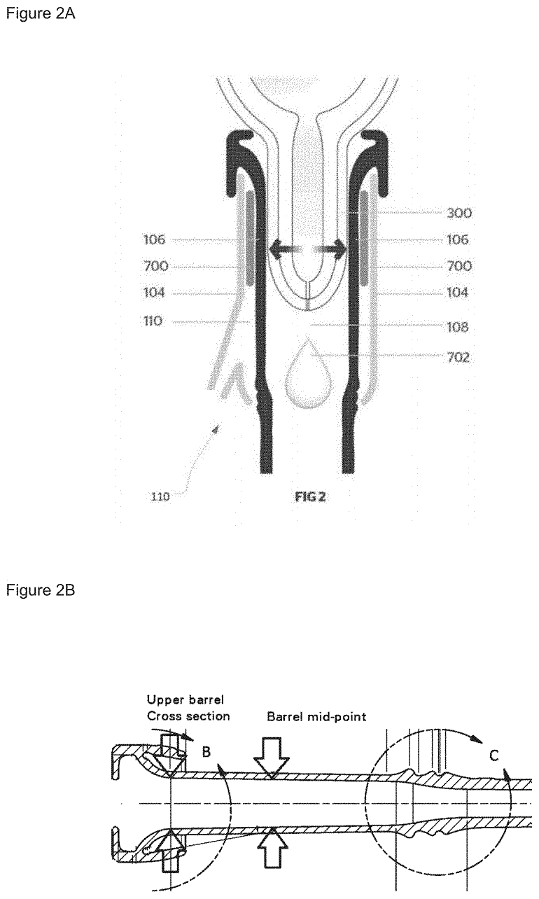

The liner includes a hollow bore for receiving an animal's teat at its upper end, and is connected to a vacuum source at its lower end via a milk line 116. The liner and shell are disposed relative to one another to create a pulsation volume 110 (see FIG. 2A) between them in which fluid pressure can be controlled cyclically. The pulsation volume 110 (otherwise known as the pulsation chamber) is connected to a vacuum source 120 via pulsation tube(s). Conventionally, the liner bore 108 and the pulsation volume 110 are applied to the same vacuum source 120 and the maximum applied vacuum levels may be substantially equal at the start and the finish of milking, although some slight differences may be experienced due to line losses along the milk line 116 and/or the pulsation tube(s).

“Vacuum” is a pressure below atmospheric pressure. The term “negative pressure” is sometimes used but in milking machine terms “vacuum” may be considered to mean “vacuum” measured on a scale in which atmospheric pressure at the time and place of measurement is zero vacuum. In this disclosure, vacuum values provided will be understood as negative values, even if not indicated. For example, a vacuum of 45 kPa, could be indicated as −45 kPa. Positive pressure will be indicated as such, generally as a positive value such as +9 kPa.

The terms “differential pressure” and “differential vacuum” are used interchangeably in this disclosure.

Maximum Liner Bore Vacuum

As milking progresses, the system-applied vacuum to the milk line 116 remains generally constant. However, milk flow reduces the vacuum in the liner bore 108 and thus the maximum vacuum applied to the teat reduces. This reduction in the milk line vacuum is exacerbated in “high line” equipment where the milk line is lifted above the claw by 1.0 metre, up to 1.80 metres. The lifting of milk creates “slugs” of milk which reduce the vacuum in the liner bore. Such high line equipment is prevalent in Australia and New Zealand. Some amelioration can be achieved by dual milk lines from the cluster, for example as found in our earlier international patent application PCT/AU2018/050416. The contents of PCT/AU2018/050416 are disclosed herein by reference. Other systems where the milk is not lifted above the claw are known as “low line” systems and are more prevalent in Europe and US.

The liner bore vacuum and the pulsation vacuum are both cyclically variable. First the pulsation volume vacuum will be explained as this affects the liner bore vacuum.

Pulsation Volume Vacuum and Vacuum Differential

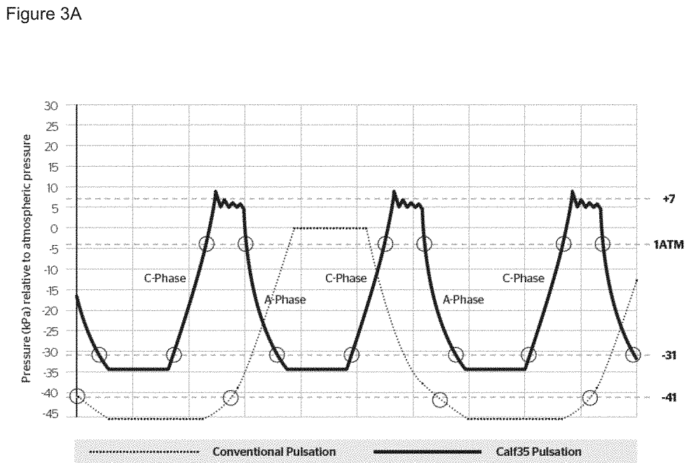

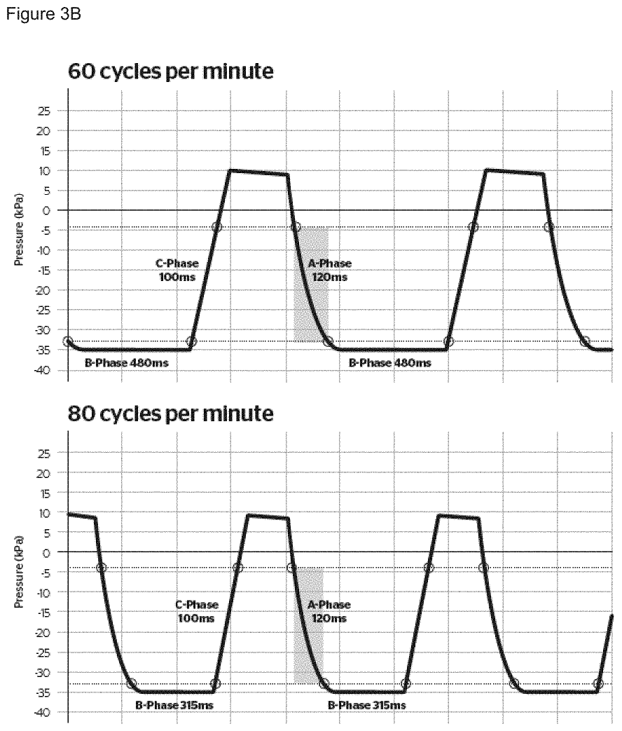

FIG. 3A illustrates a plot 500 of the air pressure level applied to the pulsation volume 110 during the pulsation cycle implementing a pressure compensation scheme as disclosed in PCT/AU2017/050412.

By modulating the pressure in the pulsation volume, a pressure differential is created across the liner between its bore and the pulsation volume to thereby control movement of the liner. Specifically, a pressure in the pulsation volume is modulated according to a pulsation cycle.

The modulation includes an “on” phase in which the vacuum applied to the liner bore (reduced due to the effect of milk flow), is less than a vacuum applied to the pulsation volume to thereby open the liner and enable milk flow from the teat.

During an “off” phase, the pulsation volume is at an increased pressure relative to the “on” phase and relative to the liner for vacuum and thus the relatively greater pressure in the pulsation volume closes off the liner bore (by the side walls of the liner bore meeting) to thereby stop milk flow from the teat. Conventionally, the increased pressure in the pulsation volume is effected by opening to atmosphere. See for instance, the plot in FIG. 3A which is labelled “conventional pulsation” which shows a pulsation volume pressure cyclically varying from a vacuum at −45 kPa in the “on” phase to 0 kPa in the “off” phase. In the conventional system, the system-applied vacuum to the milk line would also be −45 kPa, with a reduction in overall vacuum due to the presence of milk in the milk line.

PCT/AU2017/050412 discloses that the pressure modulation includes applying positive pressure to the pulsation volume during the “off” phase to apply a beneficial compressive load to the teat, the basis of our proprietary “Calf 35” system. Additionally, as explained in PCT/AU2019/050125, the use of an insert creates a beneficial compressive force pattern starting at a lowermost region of the teat and progressively extending upwardly along the teat. Such inserts can be of the type described in Australian patent AU 2008202821, the contents of which are here in incorporated by reference, and is illustrated schematically in FIG. 2A of the present application. The plots in FIG. 3A which is labelled “Calf 35” shows a pulsation cycle varying between −35 kPa to approximately +5, say to 6 to 7 kPa. The Calf 35 plot is at a higher rate, at approximately 85 and up to 90 cycles per minute which is at the higher rate than the conventional pulsation cycle.

The milking phases of the pulsation cycle are also known by the nomenclature A, B, C, D phases. The “on” or open phase is the B phase and the “off” or closed phase is the D phase. The A phase is the transition from D to B, while the C phase is the transition from B to D.

Vacuum on the Teats

When the liner closes, the vacuum within the liner bore, to which the teat is exposed will reduce. The vacuum within the liner is herein referred to as “residual vacuum”. When using a conventional system if the residual vacuum decreases below a certain threshold then cup slippage will occur. This means that the teat cups will not remain on the teats and will fall off.

Residual vacuum is a product of the milk line vacuum, which is affected by line losses along the milk line during milking. Thus, cup slippage is generally alleviated by running conventional systems at vacuums of up to 40 kPa in the case of low line systems and 45 kPa in the case of high line systems, given that high line systems suffer from greater vacuum losses. This results in higher residual vacuum and this alleviates cup slippage.

By way of example, Table 1 illustrates vacuum levels in a conventional low line milking system run at 60-63 cycles per minute (cpm) and Table 2 illustrates a conventional high line milking system run at 60-63 cycles per minute.

TABLE 1
Conventional low line milking system 60-63 CPM

| Under the | Pulsation chamber | Differential to |
|---|---|---|
| Teat Vacuum | Vacuum | open the liner. |
| kPa | kPa | kPa |
| 40 | 40 | 0 at end of milking |
| 39 | 40 | 1 low milk flow |
| 38 | 40 | 2 medium milk flow |
| 37 | 40 | 3 medium milk flow |
| 36 | 40 | 4 high milk flow |
| 35 | 40 | 5 high milk flow |
| 34 | 40 | 6 high milk flow |

TABLE 2
Conventional high line milking system 60-63 CPM

| Under the | Pulsation chamber | Differential to |
|---|---|---|
| Teat Vacuum | Vacuum | open the liner. |
| kPa | kPa | kPa |
| 45 | 45 | 0 at end of milking |
| 44 | 45 | 1 low milk flow |
| 43 | 45 | 2 low milk flow |
| 42 | 45 | 3 medium milk flow |
| 41 | 45 | 4 medium milk flow |
| 40 | 45 | 5 medium milk flow |
| 39 | 45 | 6 high milk flow |
| 38 | 45 | 7 high milk flow |
| 37 | 45 | 8 high milk flow |
| 36 | 45 | 9 high milk flow |

Teat damage occurs due to exceeding nature's inherent design load for the teat and the problem of residual vacuum as will be explained.

The usual vacuum applied by a calf to the cow's teat is anywhere up to 35 kPa. Thus, at least during low flow, particularly at the start and end of milking, the milk line vacuums exceed the vacuum level for which nature designed a cow's teat. Tissue damage will occur.

Residual Vacuum

During the “off” phase of the cycle, even though the liner is closed by the differential vacuum between the pulsation volume and the liner bore, a residual vacuum remains around the teat. For example, consider a conventional system running at a pulsation volume vacuum of 40 kPa+ with a milk line vacuum up to 40 kPa in the open phase, using a “big volume” liner and running at 60 cycles per minute: the residual vacuum levels are in the range of 16-25 kPa when the liner is closed. These values are illustrative only and partially dependent on the liner size. When such residual vacuum exceeds 18 kPa, this is a further factor (over and above vacuum in excess of 35 Kpa) which causes tissue damage to the teats.

At vacuum levels exceeding 18 kPa, the sphincter muscle starts to open and at 35 kPa the teat sphincter is fully open. As mentioned above, these levels exist in nature because the usual vacuum applied by a calf is 35 kPa. As the calf sucks on teat, it cyclically applies a vacuum of 35 kPa alternating with a lower vacuum level of below 18 kPa so that the teat receives a rest from the vacuum level which tends to open the sphincter. Thus, in conventional milking systems, where the vacuum level in the liner bore consistently exceeds 18 kPa, the sphincter muscle will remain open during the whole of milking. The sphincter muscle is not designed for such prolonged opening and places the teats under stress. This combined with B Phase vacuum in excess of 35 Kpa creates a circumstance whereby the smooth muscle in the teat's sphincter cells do not replicate. Naturally, this leads to reduced productive life for the cow. Abattoir studies of teat health have shown under such regimes that after 4 lactations, no sphincter remains.

Liner Size

The problem of cup slippage is also traditionally addressed using large volume liners which create a greater residual vacuum around the teats during the “off” phase. As with increasing system vacuum levels, larger liners also exacerbate the residual vacuum problem. Using smaller liners leaves a smaller residual vacuum during the off phase. However, this is seen as undesirable if the cups are prone to slippage.

Terms such as “big volume” liner and “small volume” liner are relative terms and indicate the liner capacity relative to the teat size. A small-volume liner will be relatively close-fitting to the teat.

Thus, the industry tends to use aggressive milking vacuums and larger liners in an effort to avoid cup slippage, both of which lead to animal health problems. The aggressive milking vacuums also achieve high yields which is attractive to the industry.

To aid understanding of the impact of line size, refer to FIG. 2B. Measuring the liner barrel at the mid-point: general comparisons:

| | |
|---|---|
| Upper Barrel Diameter | Mid-Barrel Diamter |

| | | | |
|---|---|---|---|
| Large liner | 26.5 | mm | 24 mm |
| Small liner | 22 | mm | 21 mm |

The following consideration is made in for a static position of relative space between the liner and the teat when inserted into a liner with equal vacuum in the pulsation chamber and the in the milk chamber.

Large Barrel Liner:

pi r2 for 26.5 mm barrel vs a 22 mm Diameter Barrel is 599 mm2 vs 413 mm2 cross section but if the teat is 15 mm Diameter then we have 192 mm2 teat cross section and

599 mm2−14% for the tension change=516 mm2−192 mm2=324 mm2 space between the liner and the teat when open

Vs

Small Barrel Liner:

413 mm2 minus 14% for the tension=355 mm2-192 mm2=163 mm2 space between the liner and the teat when open.

In the D Phase (off phase) the residual vacuum in the 163 mm2 space will fall more quickly and further to a lower vacuum level than will the 324 mm2 space before the A Phase is initiated again. Thus a large barrel liner leads to relatively higher residual vacuum in the D phase compared to a small liner.

Earlier Developments

In our earlier international application PCT/AU2019/050125, we described reductions in the length of the pulsation cycle, in particular through a reduction in the B phase, by truncating the unproductive latter portion of each B phase. As described, this achieves pulsation cycles of up to 89 cycles per minute while staying within the ISO standards for minimum B phase and D phase lengths.

This earlier solution ameliorates the problem of teat health by using a lower system vacuum of 35 kPa. In spite of this lower system and milk line vacuum at a maximum of 35 kPa, the problem of cup slippage is addressed because the periods between successive B phases are reduced. FIG. 3B illustrates our proprietary system “Calf 35” running at 85 cycles per minute and compares 60 CPM with 85 CPM.

As shown, the B Phase or open phase at 60 cpm is 60×480 ms for example=28,800 ms, whereas the B Phase for 85 cpm is 85×315 ms=26,775 ms. The shorter B phase at 85 CPM minimises cup slip and results in faster milking.

Typically running a milking system at 60 cpm requires a vacuum above 40 Kpa in order to stop or limit cup slip. Thus, it is possible to run a milking system at 85 CPM with 35 Kpa vacuum and achieve successful milking (minimal cup slip), fast milking, and better physiological teat condition with the lower vacuum figures as per Table 3 below.

TABLE 3
Calf 35 low line milking system at 85 CPM

| Under the | Pulsation chamber | Differential to |
|---|---|---|
| Teat Vacuum | Vacuum | open the liner. |
| kPa | kPa | kPa |
| 35 | 35 | 0 |
| 34 | 35 | 1 |
| 33 | 35 | 2 high milk flow |
| 32 | 35 | 3 |
| 31 | 35 | 4 |
| 30 | 35 | 5 |

This produces a residual vacuum on the teat in the range of 12-20 kPa. This figure is illustrative and dependent upon liner size.

However, while this solution effectively addresses teat health, the net effect is a soft movement of the liner wall with compromised displacement into the pulsation chamber to fully open the liner, particularly when the liner vacuum is equivalent to the pulsation volume vacuum. Accordingly, lower milk flows result as a consequence of incomplete opening of the liner which is commercially undesirable.

Liner Wear

As will be appreciated from Table 1 and Table 2 above illustrating a conventional system, during the B phase there is no or limited pressure differential at the start of milking. Without a pressure differential at the start of milking, the liners are reliant upon their inherent resilience to “snap open” due to the nature of the elastomeric material. For a liner which is rated to 2500 milkings, the liner material starts to lose its integrity and inherent resilience after 1600 milkings and its ability to snap open is impaired. Thus, its performance declines and is increasingly suboptimal from 1600 milkings to 2500 milkings. The upper limit of 2500 milkings is defined due to the impact of cleaning chemicals, which after 2000 to 2500 milkings progressively destroys the liner material. Additionally, at 2500 milkings, the degraded liner material retains bacteria on the surface and thus fails from a health perspective.

While some rubber based liners are designed for 2500 milkings, other liners are designed for less than 2500 milkings and some liners are designed for 1500 milking and other liners even 1250 milkings.

Silicone liners can be perform up to 8000 milkings, but will always have the opening characteristic issues (with a lesser snap open).

Liner Wear and Compressive Load

Liner wear also has a deleterious effect upon animal health and comfort. As mentioned above, the natural calf action applies a compressive load to the teat. This action alleviates congestion of blood and accumulation of lymph (edema) in the teat which would otherwise be present as a result of the vacuum applied to the teat. Thus, if the compressive load applied to the teat during milking is insufficient then blood and lymph will congest in the teat. This causes discomfort and the cow's reaction is generally too kick off the teat cup/claw. Such behaviour is also dangerous to workers and disrupts milking and reduces productivity. 22 kPa is the ideal compressive load on the teat end. Less than 20 kPa causes calluses and less than 18 kPa causes congestion on the teat. On the other hand, if the compressive load is too high, this causes damage to the teats. In the latter case, the cow is generally not aware of such damage occurring. Nevertheless, this is detrimental to cow health.

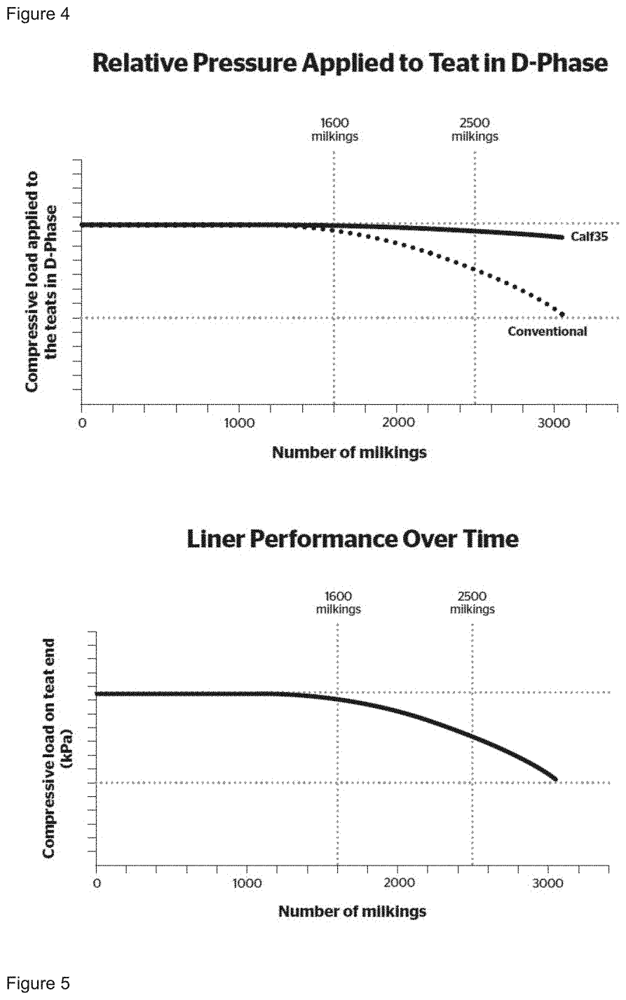

In conventional systems, where the pulsation chamber is vented to atmosphere during the D phase, about 20 kPa vacuum is required on the milk line in order to close the liner. The action of closing the liner creates a compressive load on the teat. However, the liner is also reliant upon the resilience and integrity of the liner material in order to apply the compressive load to the teat. As the liner material degrades, it loses its ability to apply compressive load to the teat as demonstrated by FIG. 4. This leads to issues with animal health and comfort as explained above. As will be appreciated, while it might be seen as desirable to reduce milk line vacuum to address the above outlined problems of exceeding nature's design limit for teat and residual vacuum, such action would only exacerbate the problem of insufficient compressive load. Therefore, attempts at reducing milk line vacuum generally fail due to cup slippage and cow discomfort due to insufficient compressive load.

In Calf 35 where positive air is injected into the pulsation chamber, the positive air injection assists in creating a compressive load on the teat. However, the compressive load is still somewhat reliant upon the resilience and integrity of the liner material and a decline in performance will still be experienced as shown in FIG. 5.

This disclosure describes example techniques which may relate to a milking system/method which addresses at least one of the aforementioned problems. This disclosure also describes providing the public with a useful choice over known methods and systems.

Reference to any prior art in the disclosure is not an acknowledgement or suggestion that this prior art forms part of the common general knowledge in any jurisdiction or that this prior art could reasonably be expected to be combined with any other piece of prior art by a skilled person in the art.

FIGS. 1a to 1c of PCT/AU2017/050412 show a schematic illustration of aspects of a milking system 100 including a pressure compensation system. FIG. 1a of PCT/AU2017/050412 is reproduced here as FIG. 1A. The contents of PCT/AU2017/050412 are incorporated herein by reference for all purposes.

The milking system includes at least one (in this example 4) milking cups 102, details of which are shown in FIG. 2A. The milking cup 102 generally includes a shell 104 and a flexible liner 106. The liner 106 is generally tubular (but may have a non-round cross section, e.g. triangular) and includes a hollow bore 108. In use the bore receives the animal's teat at its top end for milking. The lower end of the bore 108 is connected to the milking claw 114, which in turn connects to a milk tube 116. The milk tube 116 connects the liner bore 108 to a vacuum system 120 in a manner that will be known to those skilled in the art. The liner 106 and shell 104 are sealed to each other in relative positions so as to create a pulsation volume 110 between them in. As is known in the art, in order to milk the animal, the fluid pressure (vacuum) in the pulsation volume 110 is modulated. Conventionally the vacuum in the pulsation volume is used to open the bore 108 of the liner 106 to enable milk to flow within the bore 108 towards the milk tube 116. Typically the milking claw 114 will have a manifold within it that connects several liners 106 to the milk tube 116.

The vacuum system 120 generally comprises a vacuum pump that is connected to, the bore of the liner 106 (possibly via intervening connections), and the pulsation volume 110 via a pressure regulating system 122. The pressure regulating system 122, which may conventionally be a pulsator, is configured to modulate the fluid pressure in the pulsation volume 110 of the milking cup(s) 102, to cause a milking operation on the teat. The pulsator 122 is fluidly connected to the pulsation volume 110 of one or more milking cups by one or more long pulsation tube(s) 113 and respective short pulsation tubes 112. In this example the system has a 2×2 milking cluster and hence 2 long pulsation tubes 113 are used. In other embodiments a different number of long pulsation tubes may be used. As will be known the pulsation cycle of the milking operation generally includes an “on” phase in which the maximum vacuum is applied to the pulsation volume. With milk flow, a pressure differential created across the liner 106 causes its bore 108 to be opened so that the teat is exposed to the vacuum in the bore 108 to thereby enable milk flow from the teat. In an “off” phase, the pressure in the pulsation volume 110 is increased relative to the “on” phase. Conventionally, the pulsation volume 110 is opened to atmosphere by the pressure regulation system 122. The pressure differential across the liner 106 causes the liner bore 108 to close.

The system additionally includes a pressure compensation system 130. The pressure compensation system 130 primarily includes a source 132 of positive air pressure. The source could be a pump, compressor, compressed air tank, or other source of air at a pressure above atmosphere. The pressure of air delivered from the source can be controlled or set using any known mechanism, e.g. using a regulator, orifice plate, or the like. The mechanism may form part of the source 132 or be a stand-alone component of the pressure compensation system. The source 132 is in fluid communication with the pulsation volume 110 of (the or) each milking cup 102 via a positive pressure fluid delivery line 134, which in this example, joins the long pulsation tube via valve 133. As will be described in further detail below, the pressure compensation system 130 is used to selectively apply positive air pressure to the pulsation volume 110 during the “off” phase of the pulsation cycle, so that a compressive load is applied to the teat during at least part of the off cycle. To aid this process, the pressure compensation system 130 further includes:

a sensing system 136 for measuring a fluid parameter (typically pressure, volume or flow) related to a pressure in the bore 108; and

a controller 138 configured to control the pressure compensation 130 system to adjust a level of positive pressure applied to the pulsation volume 110 (see FIG. 2A).

The controller 138 receives outputs from the sensing system 136 via a communications system 140. In the present diagrams, the communication system 140 is illustrated to indicate logical connections between its elements. The system may preferably be a wireless communications system if the distance between the sensing system components and/or controller is long as this may reduce wires in an already cluttered environment and may also minimise installation costs. However a wired communication system may be used. The communications system 140 may enable communication between the controller 138 and the one or more valves 133 or actuators of the pressure compensation system 130. The pressure compensation system 130 may be a stand-alone system (e.g. that may be retro-fitted to an existing milking system) or its functions and components could be integrated, mutatis mutandis, into the pressure regulating system 122. Further details of a retro-fitted system are disclosed in our co-pending application filed 20 May 2020, details of which are incorporated herein by reference. Furthermore, the source of positive air pressure can be connected to any convenient location from which positive pressure can be delivered to the pulsation volume, in the manner required. For example, it may be connected directly to any one of the following locations:

an inlet to a pulsator;

a pulsation volume;

at a position adjacent to or along the length of either a long pulsation tube or a short pulsation tube;

a volume or manifold in fluid communication with any one of the above.

Indirect connection to such locations through a pipe, hose, valve or other means is also possible.

As noted above, the pressure compensation system 130 may be integrated into the pressure regulating system 122. FIG. 1b (which is a reproduction of FIG. 13 of PCT/AU2017/050412) shows a milking system including a pressure regulating system 122 modified in such a way. In the following description, like numbered components perform like tasks and will not be explained in detail again for the sake of brevity. In this embodiment the functions of the conventional pulsator are incorporated into a valve arrangement that controls the application of air at positive pressure and air at negative pressure (i.e. vacuum) to the pulsation tubes of the milking cluster. In this embodiment the milking system 100 includes a pressure regulating system 122 that has a three position valve arrangement 1900 coupled to:

the long pulsation tube 113 leading to the pulsation volume 110 of one or more milking cups by respective short pulsation tubes 112;

an air line 134 leading to the source of positive pressure air 132;

an air line leading to the vacuum system 120.

The controller 138 is configured to control the operation of the pressure compensation system 122 to adjust the timing of operation of the valve 1900 to selectively deliver air of either positive air pressure, or vacuum to the pulsation volume 110 via the claw 114. A wired or wireless communications system 140 is employed for communicating data between the sensor system 136 and the controller 138, and the controller 138 and the valve arrangement 1900. The pressure regulating system can include one or more valve arrangements of any type including solenoid valves, diaphragm valve or the like. In a form, the pressure compensation system and pressure regulating system are integrated into an enhanced pulsator which selectively delivers positive and negative pressure air in a controlled manner.

FIG. 3A of the present application illustrates a plot 500 of the air pressure level applied to the pulsation volume 110 during the pulsation cycle implementing a pressure compensation scheme as disclosed in PCT/AU2017/050412.

The plot 500 takes a generally saw-toothed form. Transitions from the bottom of the cycle (point of lowest vacuum) to the top of the cycle are gradual, whereas, at the onset of vacuum release, a sharper drop occurs. As should be recognised by those skilled in the art, the cycle has four phases as follows:

“B” phase, or the “On” phase in which a relatively high vacuum level is applied to the pulsation volume 110.

“D” phase, or “off” phase, in which the pressure in the pulsation volume 110 is higher (i.e. vacuum decreased) than in the B phase. In this phase the liner 106 collapses around the teat.

“A” phase is a transition between the end of the D phase and the beginning of the B phase. During this phase the pulsator 122 connects the pulsation volume 110 to the vacuum system 120 to draw air out of the pulsation volume 110.

“C” phase is a transition from the B phase to the D phase. In this phase, the vacuum in the pulsation volume 110 is released (i.e. air is allowed into the pulsation volume). Conventionally this is achieved by the pressure regulation system 122 opening the pulsation volume to atmosphere.

Embodiments of PCT/AU2017/050412 modify this conventional process as follows:

During the C phase, instead of merely opening the pulsation volume to atmosphere as per conventional, air under positive pressure is introduced into the pulsation volume 110. This causes the pressure in the D phase to be greater than atmospheric pressure. In turn this ensures that a positive compressive load is applied to the teat by the liner 106. FIG. 2A illustrates a milking cup 102 in which a teat 300 has been inserted. The resulting pressure modulation profile 500 within the pulsation volume 110 is illustrated in FIG. 3A. After the B phase, the pulsator 122 releases the vacuum in the pulsation volume 110 and the C phase is entered. Shortly thereafter (on the order of 10 ms) the air under positive pressure is applied to the pulsation volume 110 and the pressure in the pulsation volume 110 increases. However, instead of equalising at atmospheric pressure, (˜101.3 kPa), pressure is increased to above atmospheric pressure.

FIG. 3A illustrates the operation over several pulsation cycles. As will be appreciated, the C phase is conventionally initiated by the pulsator 122 opening the long pulsation tube volume to atmosphere to release the vacuum. The A phase is initiated by connecting it back to vacuum. However in order to avoid the pulsator 122 releasing the positive pressure that is added to the pulsation volume 110 during the C and D phases, the pulsator 122 is isolated from the pulsation volume 110 by a valve (valve 133 in this example). The introduction of positively pressurised air into the pulsation volume 110 is to apply compressive load to the teat to drive blood and lymphatic fluid upwards and out of the teat during the off phase of the pulsation cycle. To do this the compressive load applied is preferably above blood pressure level, say about 0.8 to 1.2 N/cm², but may preferably be in a range of 2.0 N/cm² to 3.5 N/cm², more preferably 2.0 N/cm² to 2.6 N/cm² and preferably 2.2 N/cm²

Control of the pressure compensation system 130 and in particular the determination of the level of positive pressure to be applied during the D phase so as to achieve the desired compressive load on the teat, can be performed by determining the pressure in the liner's bore 108, below the teat. The measurement, at least during the on (B) phase of the pulsation cycle is important as it has been determined by the inventor that the flow of milk in the liner bore 108 causes a reduction in the vacuum level actually experienced at the teat, regardless of the constant vacuum applied by the vacuum source 120. Thus the pressure can be determined by direct measurement of pressure in the bore 108, if suitable sensors are available, or measurement of any value that is related to this pressure. For example pressure could be measured at or near the lower end of the liner bore 108. Alternatively it could be measured in the chamber of the claw 114 or even the milk tube 116. In other forms, the pressure can be estimated by measuring milk flow rate or milk volume at the same or similar locations. To this end, a sensing system is provided that includes at least one transducer to measure a fluid parameter. In this example, the transducer is an air pressure sensor 136 in the claw 114. Since this chamber may be in fluid communication with the liners of several milking cups, the single measurement will apply to all such cups. However, measurement may be performed on a cup-by-cup basis to enable individual control of compressive load on individual teats.

The sensor 136 communicates the measured pressure data back to the controller 138 via a communications network 140. The communications network can be any type of suitable wired or wireless network. However a communications network using one or more wireless channels, (e.g. Bluetooth, Wi-Fi, ZigBee, IR, RFID, NFC, cellular technologies like 3G or 4G and the like) may be advantageously employed. In systems whose sensing systems include multiple transducers per milking cluster, the communications components for a cluster can be shared amongst the transducers, or dedicated per-transducer communications components used. The pressure sensor is arranged to transmit measured pressure data to the controller 138. The data can be sent according to any scheme, for example, it may be pushed by the sensor 136 or sent in response to a request from the controller 138. Moreover measurement can be performed continuously, intermittently or periodically depending on requirements.

The controller processes the received value and determines therefrom the pressure drop in the insert bore 108 and the necessary positive pressure to apply to the pulsation volume 110 in order to cause closing of the liner bore and application of the desired compressive load to the teat.

It was disclosed in PCT/AU2017/050412 that it is desirable to minimise the duration of the C phase of the pulsation cycle. This was seen to allow a longer D phase and possibly a longer B phase, which may be beneficial for milk production rates and animal health.

The application of positive pressure during the D phase assists with minimising cup slip and is used to cause liner closing for at least part of the C phase. Positive pressure also enhances the ability to control the timing of the pulsation curve. For example, the (A+B):(C+D) timing ratio can be controlled, as can the length of the B phase. Further, it has been appreciated that the application of positive pressure to the pulsation volume 110 itself, may cause a decrease in C phase time, but to further decrease it, and further control the application of compressive load, embodiments of the present disclosure use a milking cup with a minimised pulsation volume 110, and/or a means to control the collapse of the liner bore 108. In a form this is achieved by providing an insert within the pulsation volume 110. The insert can be of the type described in Australian patent application 2008202821, the contents of which are herein incorporated by reference, and as illustrated schematically in FIG. 2A of the present disclosure. Such inserts are sold under the brand name of “SurePulse”.

FIG. 2A illustrates a milking cup 102 with an insert 700 located in the pulsation volume 110. The insert 700 acts to minimise the air volume in the pulsation volume and acts as a collapsing means to cause sequential collapse of the liner against the teat from the lowermost part of the teat. Projections on the lower inner surface of the insert are provided that indent the liner to pinch the liner bore at a location below the tip of the teat. When positive air pressure is applied in the pulsation volume the liner 106 collapses from the position of the indentations so that compressive load is applied to the lowermost part of the teat before the application of compressive load higher up the teat. The use of the insert can assist in ensuring that the compressive load is initially applied to the lowermost 1 to 3 mm of the teat, and most preferably at the lowermost 2 mm.

By minimising the pulsation volume 110, the amount of air to be delivered to positively pressurise the pulsation volume is decreased. This enables faster application of the positive pressure and minimisation of the C phase. The reduced volume may also increase the accuracy of pressurisation of the pulsation volume as a lower volume of air needs to be applied.

Finally, the insert 700 can have further beneficial effects on teat health by limiting outwards movement of the liner 106 during the B phase, and also assisting in controlling the liner closure during the C Phase. In other embodiments a profiled shell can be used in place of the inserts. When using such shells, the inside of the shells is profiled to be dimensionally similar to the inside of the inserts described above. In this case, the collapsing means can include a projection formed on a profiled inner surface of the shell which operates like the projection on the insert.

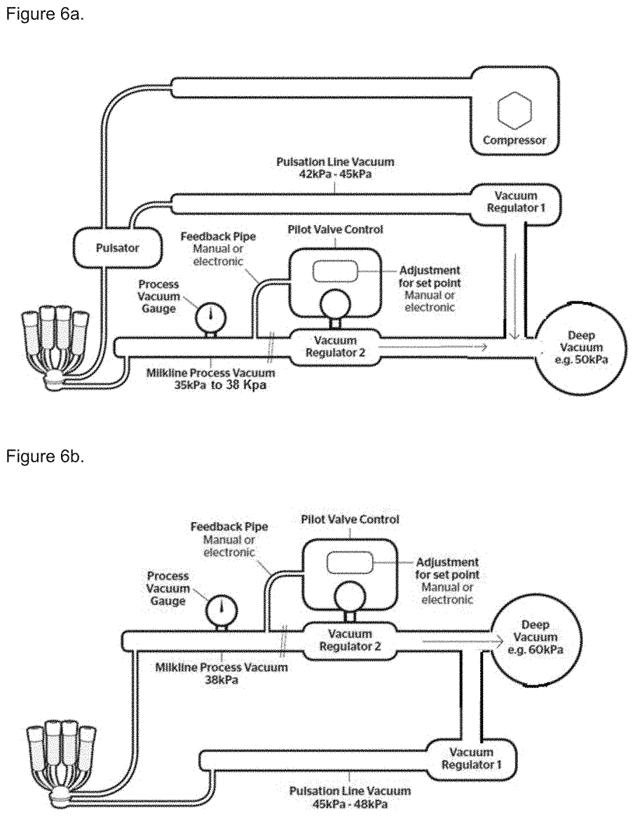

FIG. 6a and FIG. 6b are diagrams of the differential-pressure milking system according to an embodiment of the present disclosure. As the features are similar to the features illustrated in FIG. 1, like numerals have been used to represent like parts.

FIG. 6a is a diagram illustrating an exemplary system according to an embodiment of the present disclosure depicting a system able to be implemented in a low-line milking system or a high-line milking system implementing Calf 35 (aided with compressed air), to work at 85 CPM. The vacuum regulator 1 (a conventional vacuum regulator known to those skilled in the art) provides a pulsation line vacuum of −42 kPa to −45 kPa. The vacuum is regulated to provide a milk line process vacuum of −35 kPa to −38 kPa.

FIG. 6b is a diagram illustrating an exemplary system according to an embodiment of the present disclosure depicting a high-line milking system retrofitted with differential vacuum, to work at 65 to 72 CPM. The vacuum regulator 1 (a conventional vacuum regulator known to those skilled in the art) provides a pulsation line vacuum of −45 kPa to −48 kPa. The vacuum regulator 2 (vacuum splitter) provides a milk line process vacuum of −38 kPa. Accordingly, the maximum milk line vacuum will be −38 kPa, while the maximum pulsation volume vacuum will be −48 kPa. These values are maximum values because the pulsation volume vacuum will vary cyclically and the milk line vacuum will decrease due to the presence of milk in the milk line.

In each case, the vacuum regulator 1 regulates the deep vacuum to −48 kPa and then the vacuum regulator 2 (in the form of vacuum splitter) can achieve the lower vacuum on the milk line.

Alternatively, although not shown, the pressure differential could be implemented using a vacuum-splitter connected between the milk line 116 and the long pulsation tube 113.

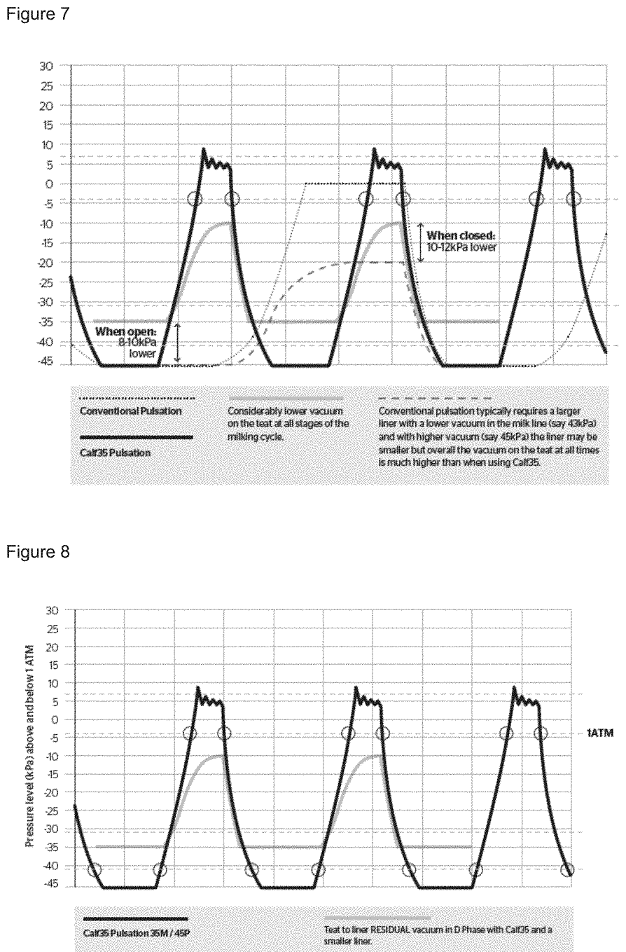

To illustrate the operation of the differential-vacuum system, FIG. 7 firstly illustrates a conventional pulsation cycle according to a system-applied maximum milk line vacuum of −45 kPa and a system-applied maximum pulsation volume vacuum of −45 kPa at approximately 60 cycles per minute, using a medium or large liner, in comparison to teat size. FIG. 7 also illustrates the cyclical vacuum pressure on the teats ranging from −45 kPa during the B phase and −20 kPa during the D phase. Thus, −20 kPa is the residual vacuum resulting from the conventional pulsation cycle.

Secondly, FIG. 7 illustrates a pulsation cycle according to a “differential-pressure” system of the present disclosure with a system-applied maximum milk line vacuum of −35 kPa and a system-applied maximum pulsation volume vacuum of −45 kPa at approximately 85 cycles per minute using a relatively small liner, in comparison to teat size. As will be understood from a study of FIG. 7, positive pressure is applied during the D phase according to our earlier disclosure. FIG. 7 also illustrates the cyclical vacuum pressure on the teats ranging from −35 kPa during the B phase to −10 kPa during the D phase. Thus, −10 kPa is the residual vacuum resulting from the differential-pressure system of the present disclosure. This value is illustrative and may vary according to liner size.

FIG. 7 also indicates the magnitude of difference between the vacuum on the teat from the conventional pulsation cycle and the differential-pressure pulsation cycle according to the present disclosure in both the off phase and the on phase. For instance, the difference in the vacuum on the teat between the conventional system and the differential-pressure system during the B phase is 8-10 kPa. The difference in vacuum on the teat between the conventional system and the differential-pressure system during the D phase is 10-12 kPa. This is better for the animal in two respects. Firstly, the latter system does not exceed nature's design limit for vacuum on the teat at −35 kPa. Secondly, the residual vacuum of −8 to −10 kPa is below the threshold at which the sphincter opens (18 kPa). Therefore, the teat is able to rest during the D phase, which prolongs teat life and animal productivity.

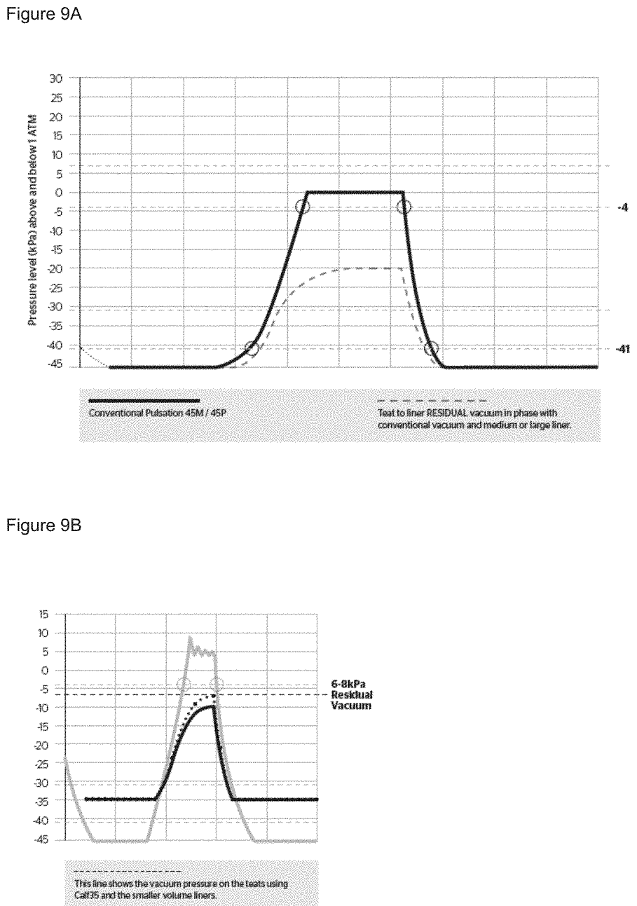

It is believed that a further improvement in residual vacuum may be achieved using a system-applied maximum milk line vacuum of −35 kPa and a system-applied maximum pulsation volume vacuum of −44 kPa at 85 cycles per minute, using a small liner. In such an arrangement, an objective for residual vacuum is as low as −6 to −8 kPa between the teat and the liner when the liner is fully closed (D phase). See for instance FIG. 9B.

By way of further illustration, Table 4 illustrates the maximum vacuum under the teat during milking, and the maximum vacuum of the pulsation volume in a low-line system at 85 cycles per minute, whereas Table 5 is a high-line system and is projected numbers only for illustrative purposes. The tables illustrate the dropping vacuum under the teat in the B phase, due to the presence of milk in the milk line. The problem is exacerbated with a high line system due to the lifting of milk and the creation of milk slugs in the line.

TABLE 4
Calf 35 with differential-vacuum in
low line milking system at 85 CPM

| | | |
|---|---|---|
| Under the | Pulsation chamber | Differential to |
| Teat Vacuum | Vacuum | open the liner. |
| kPa | kPa | kPa |

Main operating range:

| | | | |
|---|---|---|---|
| 35 | 42 | 7 | kpa |
| 34 | 42 | 8 | kpa |
| 33 | 42 | 9 | kpa |

Lower end and undesirable operating range:

| | | | |
|---|---|---|---|
| 32 | 42 | 10 | kpa |
| 31 | 42 | 11 | kpa |
| 30 | 42 | 12 | kpa |

Vacuum under the teat of the latter three values in the table above are generally undesirable because of the low compressive load resulting therefrom. Workarounds can be provided to avoid these undesirably low vacuums including: implementing a twin milk line; minimising restrictions in the milk line serving to reduce the vacuum, such restrictions including shut-off valves, and implementing non-restrictive metering systems.

Additionally, the large differential vacuums can cause increased snapping action during opening of the liner which is seen as undesirable because in places too much stress on the liner material. To some extent, the insert 700 will control the opening of the liner during the A phase.

TABLE 5
Calf 35 with differential-vacuum in high line
milking system at 85 CPM and 36 Kpa vacuum

| Under the | Pulsation chamber | Differential to | |
|---|---|---|---|
| Teat Vacuum | Vacuum | open the liner. | |
| kPa | kPa | kPa | |
| 36 | 42 | 6 | kpa |
| 35 | 42 | 7 | kpa |
| 34 | 42 | 8 | kpa |
| 33 | 42 | 9 | kpa |
| 32 | 42 | 10 | kpa |
| 31 | 42 | 11 | kpa |

This system can be adjusted in order to get the suitable timing and pressures on the teats. NOTE the highline system is most desirably implemented with the TWIN MILK lines as described in our earlier international application WO2018/201204.

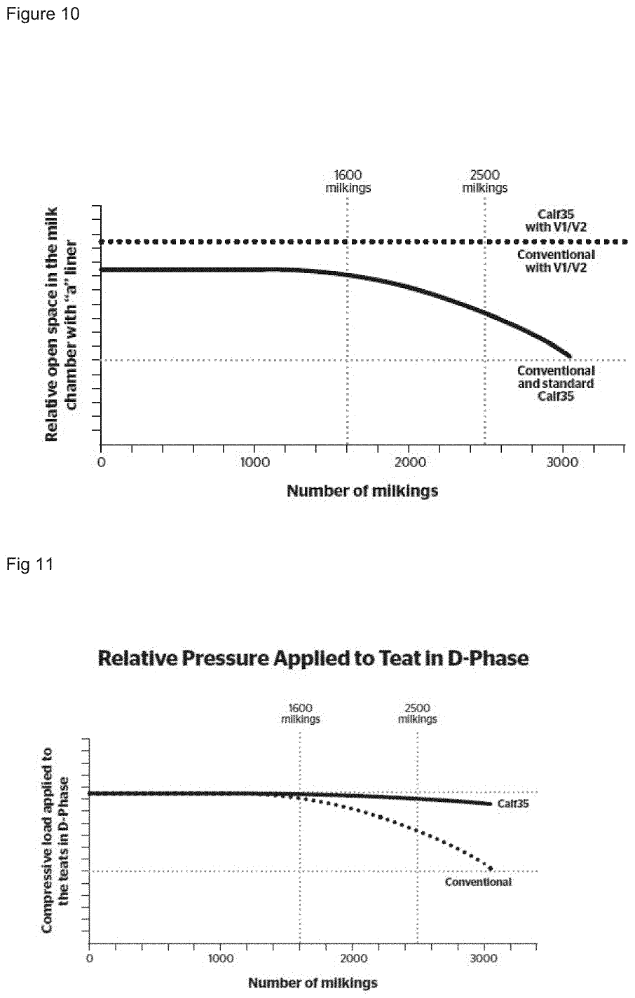

FIG. 10 illustrates the improvement in relative open space in the liner bore during the B phase between a conventional milking system, standard Calf 35, and Calf 35 implemented with differential-pressure. For ease of understanding, it will be appreciated that the nomenclature of “V 1/V 2” is intended to indicate the differential-pressure system, V1 being the milk line vacuum and V2 being the pulsation volume vacuum. The V1/V2 system preferably includes applied D-phase positive pressure in the pulsation chamber. As will be understood from an appreciation of FIG. 10, the system according to the present disclosure maintains more space in the liner bore throughout the lifespan of the liner (typically up to 2500 milkings). This is due to the effect of the differential-pressure during the opening of the liner which causes the liner to snap open. The increased vacuum in the pulsation chamber compared to the liner bore is converted to kinetic energy in the liner. Due to this opening effect, the liner is less dependent on its inherent resiliency to maintain its ability to open during milking. The upper line in FIG. 10 can be regulated by the differential vacuum (V1/V 2). Specifically, changes in the pulsation volume vacuum may be used to change the differential vacuum (V1/V2).

Because the liner is opened effectively by the differential pressure, it is possible to run the system at 85 cycles per minute because the differential pressure avoids the prior art problem of limited displacement at higher rates and thereby increasing yield. Running at a higher rate will reduce cup slip.

In view of our developments, there are thus three tools available to control liner movement:

| | |
|---|---|
| Restriction (A phase) | rate of opening |
| Air Pressure (C Phase) | rate of closing |
| Vacuum differential between the | displacement |
| pulsation and milk chambers | |

Tool 1 is elaborated in our earlier international application PCT/AU 2019/050125. Tool 2 is elaborated in PCT/AU 2017/050412. Tool 3 is the present tool. The tools of displacement now enable us to choose liners which are close fitting to the teats i.e. smaller volume liners, which in turn deliver a lower residual vacuum between the teat tissue and the liner wall while allowing complete opening of the minor bore, thereby enhancing milking speed, without detriment to animal health given the low-level vacuum at the teat end.

FIG. 11 illustrates the improvement in compressive load using Calf 35 implemented with differential-pressure compared to the compressive load in a conventional system. The necessity of compressive load is described above in the background. As will be appreciated from FIG. 11, Calf 35 implemented with V1/V2 (top line) maintains a higher compressive load at the tail end of the lifespan compared to the conventional system (bottom line).

Another benefit of the present disclosure is energy efficiency. For example, it will be understood that adding compressed air to the pulsation volume during the C phase in anticipation of the D phase requires more energy to reduce the pressure during the A phase to acquire the maximum vacuum during the B phase. While this requires additional energy, this is offset by the lower energy required in the system-applied vacuum on the milk line.

It will be understood that the disclosure disclosed and defined in this disclosure extends to all alternative combinations of two or more of the individual features mentioned or evident from the text or drawings. All of these different combinations constitute various alternative aspects of the disclosure.

What is claimed is:

1. A differential vacuum system for use with a milking system which includes: at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and a vacuum system in fluid communication with the bore of the liner and the pulsation volume; and a milk reservoir in fluid communication with the liner bore and adapted to receive milk;
wherein the differential vacuum system is configured to modulate the fluid pressure in the pulsation volume according to a pulsation cycle, to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore by more than 5 kPa.

2. The differential vacuum system as claimed in claim 1 configured such that the maximum vacuum applied to the pulsation volume exceeds the maximum vacuum applied to the liner bore in the range of more than 5 kPa and up to 10 kPa.

3. The differential vacuum system as claimed in claim 1 configured such that the maximum vacuum applied to the pulsation volume exceeds the maximum vacuum applied to the liner bore in the range of 7-7.5 kPa.

4. The differential vacuum system as claimed in claim 1 configured such that the maximum vacuum applied to the pulsation volume exceeds the maximum vacuum applied to the liner bore such that the maximum vacuum applied to the liner bore generally does not exceed 38 kPa.

5. The differential vacuum system as claimed in claim 1 wherein the maximum vacuum applied to the liner bore is designed to not exceed 35 kPa or 36 Kpa.

6. The differential vacuum system as claimed in claim 1 configured such that the maximum vacuum applied to the pulsation volume exceeds the maximum vacuum applied to the liner bore, such that the residual vacuum in the liner bore during the off phase is within the range of about 6-12 kPa.

7. The differential vacuum system as claimed in claim 6 wherein the residual vacuum within the liner bore during the off phase is 6-8 kPa.

8. The differential vacuum system as claimed in claim 1 wherein the pulsation cycle has a duration selected from any one or more of the following:
less than 950 ms, less than 900 ms; less than 850 ms; less than 800 ms; less than 750 ms; less than 700 ms; less than 675 ms; at or about 674 ms; 600 ms or above; 650 ms or above; 700 ms or above; 7500 ms or above; 800 ms or above; 850 ms or above; 900 ms or above; 950 ms or above; or within a range defined by any pair of the above listed durations.

9. A differential vacuum system for use with a milking system which includes: at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; a vacuum system in fluid communication with the bore of the liner and the pulsation volume; and a milk reservoir in fluid communication with the liner bore and adapted to receive milk;
wherein the differential vacuum system is configured to modulate the fluid pressure in the pulsation volume to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore, such that the residual vacuum in the liner bore during the off phase is within the range of about 6-12 kPa.

10. The differential vacuum system as claimed in claim 9 configured such that the residual vacuum within the liner bore during the off phase is within the range of 8-12 Kpa.

11. The differential vacuum system as claimed in claim 9 configured such that the residual vacuum within the liner bore during the off phase is 6-8 kPa.

12. A differential vacuum system for use with a milking system which includes: at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and a vacuum system in fluid communication with the bore of the liner and the pulsation volume;
wherein the differential vacuum system is configured to modulate the fluid pressure in the pulsation volume to cause a milking operation on a teat of an animal that is inserted into the bore, including an “on” phase to open the liner and thereby enable milk flow from the teat, and an “off” phase in which the pulsation volume is at an increased pressure relative to the “on” phase to close the liner bore to thereby stop milk flow from the teat, wherein the differential vacuum system controls the maximum vacuum applied to the pulsation volume to exceed the maximum vacuum applied to the liner bore and controls application of positive pressure to the pulsation volume before and/or during the off phase to apply compressive load to the teat.

13. The differential vacuum system of claim 12 configured such that the compressive load to the teat provides massage in the range of 22-26 kPa on the teat.

14. The milking system of claim 12, further including:
at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and
an insert to control the opening of the liner.

15. The milking system of claim 1, wherein the milking system further includes at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and a vacuum system in fluid communication with the bore of the liner and the pulsation volume; and a milk reservoir in fluid communication with the liner bore and adapted to receive milk, wherein the milking system is configured to apply positive pressure to the pulsation volume before and/or during the off phase to apply compressive load to the teat.

16. The milking system as claimed in claim 15 wherein the compressive load provides massage in the range of 22-26 kPa on the teat.

17. The milking system as claimed in claim 15 further including an insert to control the opening of the liner.

18. The milking system of claim 9, wherein the milking system further includes at least one milking cup of the type including a shell and a flexible liner, said liner including a hollow bore for receiving an animal's teat, and for being connected to a vacuum source; the liner and shell being disposed relative to one another to create a pulsation volume between them in which fluid pressure can be controlled in order to control a pressure differential across the liner between its bore and the pulsation volume to thereby control movement of the liner and the application of air pressure to the animal's teat; and a vacuum system in fluid communication with the bore of the liner and the pulsation volume; and a milk reservoir in fluid communication with the liner bore and adapted to receive milk, wherein the milking system is configured to apply positive pressure to the pulsation volume before and/or during the off phase to apply compressive load to the teat.

19. The milking system as claimed in claim 18 wherein the compressive load provides massage in the range of 22-26 kPa on the teat.

20. The milking system as claimed in claim 18 further including an insert to control the opening of the liner.
